(19) United States
(12) Patent Application Publication
(10) Pub. No.: US 2026/0086803 A1
(43) Pub. Date: Mar. 26, 2026

(54) SYSTEM, METHOD AND APPARATUS FOR PREDICTING LOAD ADDRESSES IN A MEMORY SUBSYSTEM

(71) Applicant: Intel Corporation, Santa Clara, CA (US)

(72) Inventors: Mark Dechene, Hillsboro, OR (US); Thomas Mullins, Sunnyvale, CA (US); Anita Tino, Mississauga (CA)

(21) Appl. No.: 18/898,447

(22) Filed: Sep. 26, 2024

(51) Int. Cl. G06F 9/30; G06F 9/38

(52) U.S. Cl. CPC G06F 9/30043; G06F 9/3806; G06F 9/3867

(57) ABSTRACT

In one embodiment, a method includes: receiving, in a prediction circuit associated with a cache memory of a processor, a load operation to load information stored in a memory; accessing at least one prediction structure of the prediction circuit to obtain prediction information associated with the load operation, the prediction information comprising a predicted virtual address for the load operation; and dispatching the load operation to a load pipeline of the processor using the predicted virtual address for the load operation. Other embodiments are described and claimed.

### BACKGROUND

In highly superscalar processors, especially such processors having clustered execution or sliced memory subsystems, there can be a high round-trip latency between an address generation unit and a memory subsystem. A load operation is an action to obtain requested information from the memory subsystem. Some loads are dependent on the results of other load operations, and these load-dependent loads are often latency sensitive, which can adversely affect performance.

### BRIEF DESCRIPTION OF THE DRAWINGS

FIG. 1 is a block diagram of a hardware processor having a cache memory in accordance with an embodiment.

FIG. 2 is a flow diagram of a method in accordance with an embodiment.

FIG. 3 is a flow diagram of a method in accordance with another embodiment.

FIG. 4 is a flow diagram of a method in accordance with an embodiment.

FIG. 5 is a flow diagram of a method in accordance with another embodiment.

FIG. 6 is a flow diagram of a method in accordance with yet another embodiment.

FIG. 7 is a block diagram of a portion of a processor in accordance with an embodiment.

FIG. 8 illustrates an example computing system.

FIG. 9 illustrates a block diagram of an example processor in accordance with an embodiment.

FIG. 10 is a block diagram of a processor core in accordance with an embodiment.

### DETAILED DESCRIPTION

In various embodiments, a cache memory, such as a level 1 (L1) cache memory, may be configured with prediction circuitry to perform predictions of addresses for access by load operations. In this way, such load operations can be provided to a load pipeline earlier than otherwise would occur when waiting for calculation of an address by address generation circuitry.

As will be described herein, this prediction circuitry may leverage one or more prediction tables that are associated with the cache memory. Although embodiments are not limited in this regard, in example implementations these prediction tables may include a table for constant address predictions, another table for linked producer-consumer load operations, among additional tables, as will be further described herein.

Embodiments may realize reduced latency for various loads, including loads having a single register source directly dependent on another load (e.g., with a limited-size immediate offset). Similarly, latency may be reduced for loads indirectly dependent on another load, as the prediction circuitry described herein can track and learn producer/consumer load pairs.

More specifically, when a load (the “producer”) produces data that is used to calculate the address of another load (the “consumer”), and that calculation is a simple constant offset added to the data, the consumer's address can be calculated locally within the cache memory given the writeback of the producer. Or the calculation can occur at another time prior to dispatch of the consumer. This calculated address is broadcast to a portion of the cache memory where the consumer will dispatch, enabling it to dispatch some number of cycles early. Embodiments provide a number of mechanisms to associate producers with consumers, including a predictor that learns load pairs that may be indirectly dependent, and detection of a direct dependence by register rename circuitry.

Embodiments may thus reduce load latency, especially in chains of load-dependent loads. While the implementations described herein are in the context of a processor having execution clustering and memory slicing, embodiments may also be implemented in processors without execution clustering or without memory slicing.

In certain examples, a hardware processor core includes memory circuitry (e.g., as an “execution circuitry” of the core). In certain examples, the memory circuitry processes memory requests and page translation requests from front end circuitry (e.g., including fetch circuitry for fetching instructions from memory, decoder circuitry for decoding instructions, and delivering them to scheduling/execution circuitry). In certain examples, memory circuitry processes load operations (e.g., load micro-operations (pops)) and store operations (e.g., store micro-operations (pops)), returning the results, and/or final status (e.g., complete or incomplete (e.g., fault)) to the out-of-order (OOO) circuitry for subsequent instructions and/or instruction retire. In certain examples, memory circuitry receives off core (e.g., uncore) snoops and ensures that correct coherence actions are taken in the core. In certain examples, memory circuitry is sub-divided into multiple sections.

Data may be stored in a processor's cache (e.g., of any level, such as, but not limited to, L3, L2, L1, etc.), system memory (e.g., separate from a processor), or combinations thereof. In certain examples, memory is shared by multiple cores. In certain examples, a cache line is a section (e.g., a sector) of memory (e.g., a cache) that is managed as a unit for coherence purposes. In certain examples, a cache line is referenced by an (e.g., virtual) address, e.g., a program address that the memory maps to a physical address. A virtual address may be a linear address. Mapping may occur during a process referred to as translation. In certain examples, a linear address is formed by adding (e.g., concatenating) a segment address (e.g., referred to by a segment selector) to the virtual address (e.g., virtual offset).

To effectively manage complexity, in certain examples some processor circuitry is divided internally into clusters, and in turn at least certain cache memory circuitry can be divided into slices. In certain examples, slices divide the memory instruction stream based upon the (e.g., linear) addresses the instructions access. In certain examples, slices create an inherent proof that certain memory instructions can mostly ignore other instructions, and therefore reduce ordering and correctness checks, when different memory instructions have been assigned to different slices. In certain examples, slices are most effective when the memory address pattern is relatively balanced across cache lines. In certain examples, the memory circuitry in at least the L1 memory circuitry is sliced. As will be described further herein, at least this sliced L1 memory circuitry may include prediction circuitry as described herein. In certain examples, to transition between the cluster domain and the slice domain, memory operations traverse a crossbar (e.g., a crossbar switch).

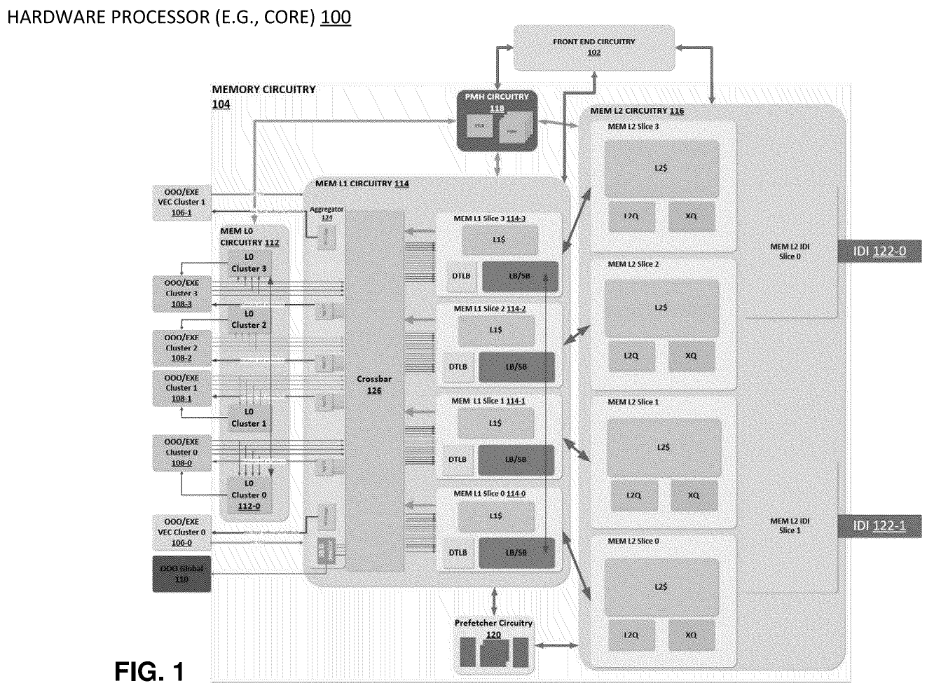

FIG. 1 illustrates a block diagram of a hardware processor (e.g., core) 100 comprising a set of clusters of execution circuits coupled to memory circuitry that includes a level (e.g., L1) of memory circuitry that is sliced according to address values. Depicted processor (e.g., core) 100 includes front end circuitry 102 (e.g., including fetch circuitry for fetching instructions from memory, decoder circuitry for decoding instructions, and delivering them to scheduling/execution circuitry). Depicted processor (e.g., core) 100 includes out-of-order (OOO) (e.g., out of program order) and execution clusters, e.g., a vector out-of-order (OOO) (e.g., out of program order) and execution clusters 106-0 to 106-1 (although two vectors clusters are shown, a single, none, or any plurality of vector clusters may be utilized in certain examples), and (e.g., scalar) out-of-order (OOO) (e.g., out of program order) and execution clusters 108-0, 108-1, 108-2, and 108-3 (although four scalar clusters are shown, a single, none, or any plurality of scalar clusters may be utilized in certain examples). In certain examples, the hardware processor (e.g., core) 100 includes OOO global circuitry 110, e.g., to maintain global ordering in an out-of-order superscalar processor core. In certain examples, the OOO global circuitry 110 includes circuitry to maintain global ordering in a processor core that utilizes multiple clusters to execute multiple strands.

Depicted processor (e.g., core) 100 includes memory circuitry 104, e.g., as a multiple level cache. In certain examples, the memory circuitry 104 includes a coupling to additional (e.g., system) memory, for example, in-die interface (IDI) 122-0 and/or in-die interface (IDI) 121-1.

In certain examples, the memory circuitry 104 includes five distinct sections (e.g., parcels): L0 memory circuitry (e.g., L0 MEM) 112, L1 memory circuitry (e.g., L1 MEM) 114, L2 memory circuitry (e.g., L2 MEM) 116, page miss handler (PMH) circuitry 18, and prefetcher circuitry 120.

An exemplary execution cluster 108-0 is coupled to an exemplary cluster 112-0 of a level (e.g., L0) of memory circuitry according to examples of the disclosure. Depicted cluster 108-0 may include an address generation unit to generate address, e.g., for memory accesses and/or a scheduler/reservation station, e.g., to schedule memory access operations for servicing in memory circuitry (e.g., L0 MEM, L1 MEM, L2 MEM, etc.).

In the embodiment of FIG. 1, L0 MEM 112 is divided into clusters. For example, with one cluster of L0 MEM 112 attached to one OOO cluster, e.g., cluster 112-0 of L0 MEM 112 attached to OOO cluster 108-0, etc. In order to provide scalable performance, the L1 MEM 114 is sliced by address. In certain examples, a given cache line of memory may only exist in a single slice of L1 MEM. In certain examples, there are a plurality (e.g., shown as 4 slices, although other numbers of slices may be utilized) of L1 MEM 114, where each slice contains a different range of address values compared to the other slices. In certain examples, after a load or store has passed address generation, the appropriate L1 slice for that memory operation is determined by looking at the (e.g., linear) address bits of the load or store.

In certain examples, the OOO circuitry is organized into a plurality of (e.g., 4) clusters which feed memory operations (e.g., pops) to the (e.g., same number of) L1 MEM slices. However, in certain examples, the cluster is address agnostic and does not know ahead of time to which slice it should send the memory operation (e.g., pop). As such, in certain examples, the OOO (e.g., of an OOO/EXE cluster) broadcasts the memory operations (e.g., pops) (e.g., via a DispatchAGU indication) to all slices, and a certain number of cycles later the EXE (e.g., of an OOO/EXE cluster) broadcasts the address it computed. In certain examples, each slice will check the (e.g., linear) address (e.g., a proper subset of the bits, e.g., bits in bit positions [7:6]) and determine whether the memory operation (e.g., pop) belongs to the slice.

The MEM L1 circuitry 114 includes a crossbar 126 as a set of couplings (e.g., wires) which connect all OOO/EXE clusters to all L1 MEM slices. In certain examples, the crossbar 126 of the L1 MEM circuitry 114 is responsible for transmitting load memory operations (e.g., load pops), store address memory operations (e.g., store address pops), and store data memory operations (e.g., store data pops) from OOO and EXE clusters into L1 MEM slices. In certain examples, while loads and stores have specific target slices based on their address, the information is broadcast to all slices, and each slice makes its own decisions on what data to catch and process.

In certain examples, the crossbar 126 of the L1 MEM circuitry 114 is responsible for transmitting results from L1 MEM slices back to OOO and EXE clusters. In certain examples, each L1 memory slice can send responses to any OOO/EXE cluster, e.g., and the responses are sent back over the crossbar 126 to all clusters. In certain examples, the L1 MEM aggregator 124 is a sub-component of L1 MEM 114 that deals outside of the sliced memory domain. In certain examples, the L1 aggregator 124 is responsible for coordinating the L1 slices and their communication with other components, e.g., circuitry.

In certain examples, after AGU, a load crosses the L1 MEM crossbar and arrives at a specific L1 MEM slice based on the linear address. In certain examples, once in L1 MEM, the load will arbitrate for a load pipe, which it will eventually win. In certain examples, the load pipeline is responsible for page translation, L1 data cache lookup, and resolving memory ordering against stores. In certain examples, the load will schedule down a load pipeline one or more times, until the load eventually binds to data and writes back the data to EXE and completes.

In certain examples, the memory circuitry 104 includes page miss handler (PMH) circuitry 118 to service page translation misses on behalf of the first level TLBs, translating linear addresses into physical addresses, and producing TLB entries to fill the first level TLBs. In certain examples, the PMH circuitry 118 includes a second-level TLB queue to receive requests, a second-level TLB, a pipelined page walker state machine capable of handling multiple requests in flight, page walk caches, virtualization page walk caches, etc.

Execution clustering separates the out-of-order scheduling (OOO) and execution units (EXE) into a plurality (e.g., 4) loosely coupled clusters. Loads and stores to any address might come from any cluster.

As shown in FIG. 1, memory slicing separates the L1 and L2 cache memory into a plurality of loosely coupled slices. The total memory address space is partitioned among these slices. When a load calculates its address in an execution circuit, the opcode and address travel over the crossbar to the correct slice for that address. When a load writes back data, the data travels over the crossbar to the originating cluster. This crossbar represents several cycles of round-trip latency. With an embodiment, when a load's address can be calculated within the cache memory based on another load's data, it can reduce time spent in the crossbar, or eliminate it completely if the loads happen to fall within the same slice.

Calculation of load addresses can be based on detection of dependencies during broadcasts, or it can be predicted based on past load/load pairs observed, or a load's address can be predicted outright without any dependence on prior loads. In scenarios such as a pointer chasing loop where a load's data is repeatedly used to calculate another load's address, embodiments can reduce load latency. With a predictor in accordance with an embodiment, a load address can be predicted even when there is an arithmetic operation between loads, and even where the loads are not directly dependent.

To this end, prediction and related circuitry may be implemented within various portions of a processor. For example, core 100 having multiple execution and other cluster circuitry can implement a sliced cache architecture for one or more cache levels such as the L1 cache 114 discussed above. In addition, the core and/or other processor circuitry can include a load pipeline having a plurality of stages through which load operations traverse to obtain requested information from a memory subsystem. Note that the prediction circuitry including the predictors and associated predictor tables described herein may be implemented internally or externally to the sliced cache memory (e.g., L1 cache 114, including portions included within the cache and portions outside of the cache, e.g., within the load pipeline), or otherwise associated with the slices or other portions of the cache memory.

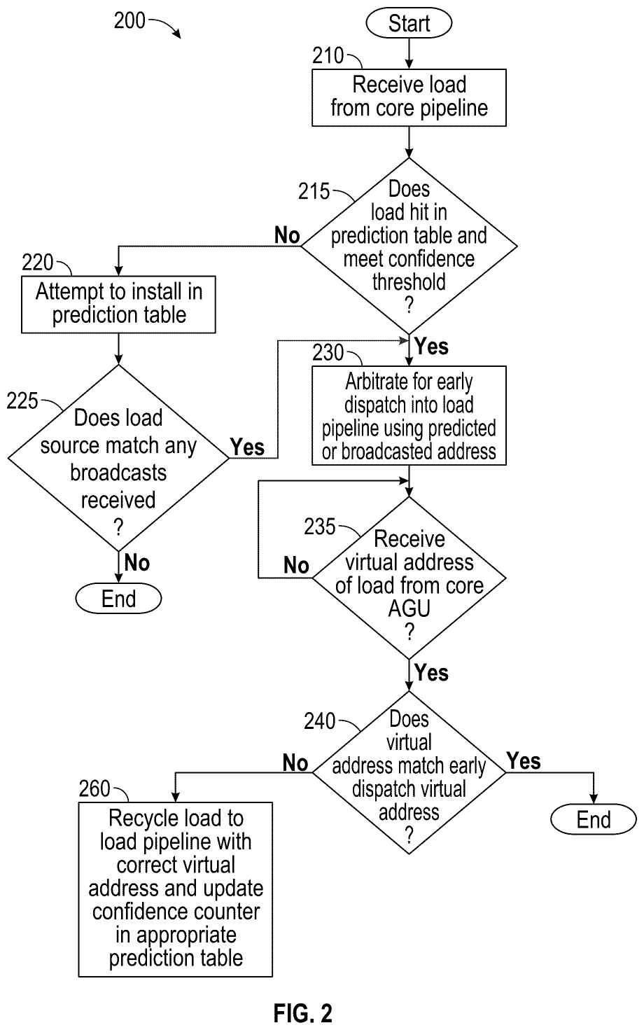

Referring now to FIG. 2, shown is a flow diagram of a method in accordance with an embodiment. In the high level view shown in FIG. 2, method 200 is a method for handling load operations in a cache memory while leveraging prediction circuitry as described herein. As such, method 200 may be performed by hardware circuitry, which may be present at least in part in a load pipeline, the cache memory and/or other core circuitry, possibly along with firmware and/or software.

As illustrated, method 200 begins by receiving a load operation from a core pipeline (block 210). As an example, an allocation or dispatch circuit of a processor pipeline may send this load operation to the load pipeline. This load operation may be initiated responsive to a given load instruction, which in some cases can be implemented as one or more load micro-operations (pops). Control next passes to diamond 215 to determine whether this load operation (or a broadcast of a predicted address from another slice) hits in one or more prediction tables. A load operation hits when there is an entry associated with the load operation within one of the prediction tables (e.g., where the prediction tables may be indexed using an instruction pointer (IP) of the load operation). As described above, there may be multiple tables present. And if the load operation hits as determined at diamond 215, it is also considered whether a confidence of a prediction stored in the hit entry meets a given confidence threshold. It can also be determined at diamond 215 whether the load hits a received broadcast. If no hit occurs, control passes to block 225, where the load/broadcast may be installed into a given one of the prediction tables.

If the load hits within a given prediction table (and is a confident prediction), a predicted address can be accessed from the hit entry. Then at block 220 the load operation, with its predicted address, can be provided to further stages of the load pipeline, where it may seek early dispatch into the load pipeline via an arbitration with other load operations seeking to enter the load pipeline. To this end, an arbitrator of the load pipeline may perform this arbitration.

Still referring to FIG. 2, control passes to diamond 230 where it is determined whether a virtual address (VA) of the load operation is received from an address generation circuit (e.g., an address generation unit (AGU) of the core). If so, control passes to diamond 240 to determine whether the virtual address received from the address generation circuit matches the predicted address (namely a virtual address) used in the early dispatch. If the addresses match, this means that the predicted address previously obtained from an entry of a given prediction table was the correct address.

Still referring to FIG. 2, if the predicted address and the virtual address obtained from the address generation circuit do not match, control passes to block 260. At block 260, the early dispatch of the load operation (which was dispatched with an incorrect predicted address) is recycled to the load pipeline with the correct virtual address. Also at block 260, the confidence counter of that entry in the given prediction table may be updated. More specifically, a confidence counter for the predicted address may be decremented to indicate a lesser confidence, given the mismatch in addresses. Although shown at this high level in the embodiment of FIG. 2, many variations and alternatives are possible.

As discussed above, prediction circuitry of a cache memory may include one or more prediction tables. In one implementation, a first prediction table may be implemented as part of a constant address predictor. This constant address predictor may be used to perform predictions for load operations that have a constant address.

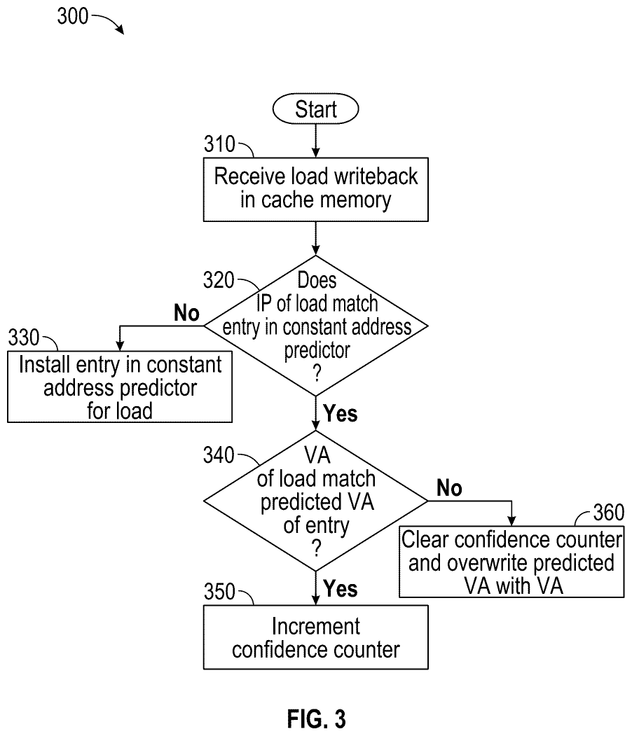

Referring now to FIG. 3, shown is a flow diagram of a method in accordance with another embodiment. More specifically, method 300 is a method for accessing a prediction table of a constant address predictor in accordance with an embodiment. As such, method 300 may be performed by hardware circuitry of a load pipeline and/or cache memory having such a predictor. As shown, method 300 begins by receiving a load writeback in the cache memory (block 310). Understand that this load writeback is a return of data for a load operation. At diamond 320, it is determined whether an instruction pointer of the load matches an entry in the constant address predictor (namely a prediction table of the predictor). If not, control passes to block 330 where an entry in the constant address predictor table may be installed for the load. In an embodiment, each entry of the constant address predictor may include various fields to store information, including a tag field (which may store a tag portion of an IP of a load address), an address field to store a predicted virtual address of the load, and a confidence field to store a value of a confidence counter for the load.

Still referring to FIG. 3, instead if it is determined that the IP of the load matches an entry in the constant address predictor table, control passes to diamond 340 to determine whether a virtual address of the load matches the predicted virtual address stored in the entry. If so, at block 350, the confidence counter of the entry is incremented. Otherwise, if the virtual address of the load does not match the predicted virtual address of the entry, at block 360 the confidence counter is cleared, and the virtual address stored in the entry is overwritten with the virtual address for the load writeback. Although shown at this high level in the embodiment of FIG. 3, many variations and alternatives are possible.

In different embodiments, the CAP may be implemented within a storage array of the load pipeline and/or a data array of the cache memory and may be a table having a plurality of entries that are indexed by IP. Each entry holds the most recent virtual address a load accessed and a confidence counter.

Referring to Tables 1 and 2 below, shown are exemplary details of a CAP table and a CAP table entry, respectively, in accordance with an embodiment.

TABLE 1
CAP Array Summary

| | |
|---|---|
| entries | 256 |
| ways | 4 |
| read ports | 4 |
| write ports | 1 |

TABLE 2
CAP Entry

| Name | Width | Description |
|---|---|---|
| valid | 1 | Entry is valid |
| tag | 10 | Tag bits of IP |
| address | 48 | Predicted virtual address |
| confidence | 4 | Confidence counter |

As described above, there may be multiple predictors present in the prediction circuitry of a cache memory. In an embodiment, another predictor may be implemented as a load link predictor (LLP) that predicts a delta between a producer load's writeback data and a consumer load's virtual address. This LLP may include an LLP table that is indexed by a producer load's IP, and each entry may be configured to provide prediction information for one or more consumers, in an embodiment. The predicted delta may act very similar to a simple load's immediate offset and may leverage the same simple AGU.

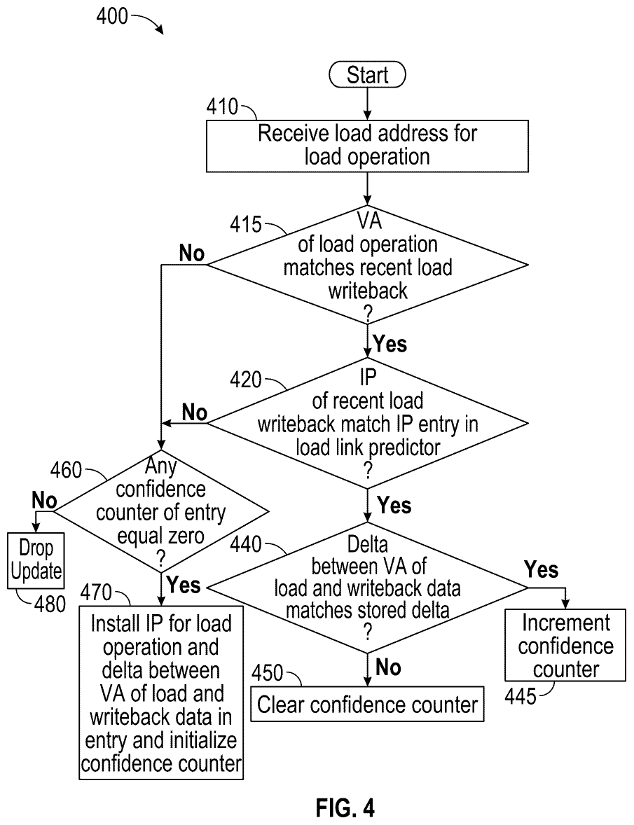

Referring now to FIG. 4, shown is a flow diagram of a method in accordance with an embodiment. Method 400 is a method for accessing and using a LLP, in accordance with an embodiment. As such, method 400 may be performed by hardware circuitry of a load pipeline and/or cache memory having such a predictor.

As shown, method 400 begins by receiving a load address for a load operation (block 410). At diamond 415, it is determined whether the virtual address of a load operation matches a recent load writeback.

Still referring to FIG. 4, if the virtual address matches this load writeback, control passes to diamond 420 to determine whether an IP of the recent load writeback matches an IP in an entry in the load link predictor (namely a prediction table of the LLP). If not, control passes to diamond 460, discussed below.

Still referring to FIG. 4, if at diamond 420 it is determined that the IP of the recent load writeback matches an IP in an entry in the load link predictor table, control passes to diamond 440, where it is determined whether a delta between the virtual address of the load operation and the writeback data matches the stored delta. If so, at block 445, the confidence counter associated with this consumer may be updated, i.e., incremented. If the deltas do not match, control passes instead to block 450 where the confidence counter is cleared.

Still referring to FIG. 4, if instead at diamond 420 it is determined that the IP of the recent load writeback does not match an IP in an entry of the LLP, control passes to diamond 460 to determine whether any of the confidence counters present in the entry equal zero. If so, the IP for the load operation may be installed in that entry (for the previous field having an associated zero confidence counter). In addition, the delta between the load address (VA) and the writeback data may be stored in the entry, and the confidence counter may be initialized (updated to a value of one. Otherwise, if at diamond 460 it is determined that none of the confidence counters in the entry equal zero, there is no update performed (block 480). Although shown at this high level in the embodiment of FIG. 4, many variations and alternatives are possible.

In an embodiment, each slice of a cache memory can have an independent LLP. In one implementation, when a load address is received, the upper bits (e.g., VA [63:10]) are checked against several cycles of recent writebacks. If a match is found, it is used to update the LLP. If the producer is not in the LLP table, a new entry is installed. If the producer is in the LLP table and any consumer IP matches: if the delta matches, the counter is incremented; and if the delta does not match, the counter is cleared. If no consumer IP matches: if any counter is 0, the new consumer is installed at confidence 1; and if all counters are above 0, the update is dropped.

In an embodiment, entries of the LLP table may include link information associated with producer/consumer load pairs. Each entry may include a tag portion of the IP address of the producer stored in a tag field, an IP of the consumer load stored in a consumer IP field. In addition, a delta field may store a value that corresponds to a difference between the consumer virtual address and the producer data (namely, the load writeback data). Note that a load buffer ID may also be used to uniquely identify the load pair without IP data aliasing as in the case of nested loops.

Referring to Tables 3 and 4 below, shown are exemplary details of a LLP table and a LLP table entry, respectively, in accordance with an embodiment.

TABLE 3
LLP Array Summary

| | |
|---|---|
| entries | 256 |
| ways | 4 |
| read ports | 4 |
| write ports | 1 |

TABLE 4
LLP Entry

| Name | Width | Description |
|---|---|---|
| valid | 1 | Entry is valid |
| tag | 10 | Tag bits of producer IP |
| ip1 | 16 | First consumer's IP |
| delta1 | 10 | First consumer's VA minus producer data |
| confidence1 | 4 | First consumer's confidence |
| ip2 | 16 | Second consumer's IP |
| delta2 | 10 | Second consumer's VA minus producer data |
| confidence2 | 4 | Second consumer's confidence |

If an AGU calculation is simple enough, a cache memory can perform it locally. In an embodiment, a load is considered to be simple if it meets the following criteria: no more than one register source, originating from a load; an immediate offset no more than 10 bits wide (−512 to 511); no scale; and no segment base. Of course, other criteria can be used in other embodiments.

If an allocating simple load matches its source physical register (PSRC) against any load destination physical register (PDST) from recent cycles, that provides a link with producer load buffer ID (LBID), consumer LBID, and the load's immediate offset.

If an allocating load hits the LLP, it writes the producer LBID, consumer IPs, and predicted delta into an entry in a side table (where the entry may persist for at least several cycles). The next load to hit a consumer IP in this side table provides a link with producer LBID, consumer LBID, and predicted offset. These producer/consumer links are written into a LBID-indexed Producer Prediction Table (LB-PPT). Each slice has its own LB-PPT. When the producer writes back, if it has any valid predictions in the LB-PPT, it calculates the predicted consumer addresses and broadcasts them to all slices.

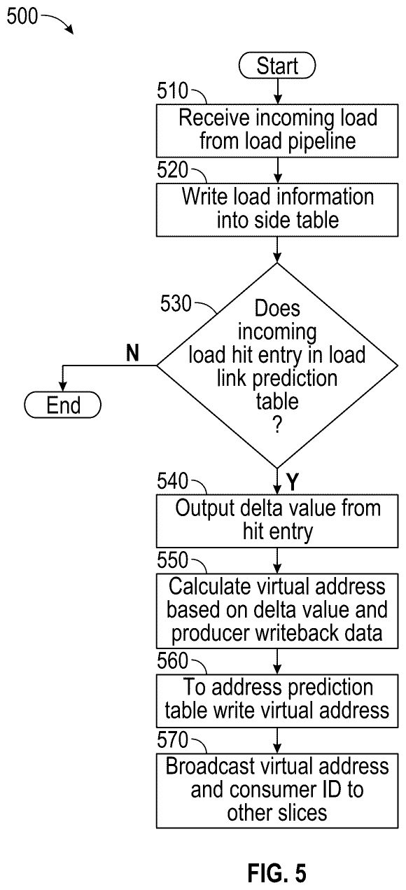

Referring now to FIG. 5, shown is a flow diagram of a method in accordance with another embodiment. More specifically, method 500 of FIG. 5 is a method for performing predictions using a PPT in accordance with an embodiment. As shown, method 500 begins by receiving an incoming load in the load pipeline (block 510). This incoming load may be received from an allocation stage of the pipeline. At block 520, load information for this load is written into a side table, which may store load information of recently received load operations. Next at diamond 530, it can be determined whether this load hits an entry in a LLP table. Note that in some implementations, these operations at block 520 and diamond 530 can be performed in parallel.

If so, information from the hit entry can be output, namely a delta value (block 540), which may be provided to an address generation circuit of the prediction circuitry. At block 550 this address generation circuit may calculate a virtual address based on this delta value and producer writeback data. This calculated virtual address and associated information, e.g., a consumer ID, may be written to an address prediction table of the slice (block 560), and is broadcast to other slices at block 570. Understand that these other slices may receive this prediction information and write appropriate entries within an address prediction table of the slice. Although shown at this high level in the embodiment of FIG. 5, many variations and alternatives are possible.

Referring to Tables 5 and 6 below, shown are exemplary details of a PPT table and a PPT entry, respectively, in accordance with an embodiment.

TABLE 5
LB-PPT Array Summary

| | |
|---|---|
| entries | 1680 |
| banks | 4 |
| read ports | 1 |
| write ports | 1 |

TABLE 6
LB-PPT Entry

| Name | Width | Description |
|---|---|---|
| valid1 | 1 | First consumer prediction is valid |
| lbid1 | 11 | First consumer's LBID |
| delta1 | 10 | First consumer's VA minus producer data |
| valid2 | 1 | Second consumer prediction is valid |
| lbid2 | 11 | Second consumer's LBID |
| delta2 | 10 | Second consumer's VA minus producer data |

Address predictions are written into a LBID-indexed Address Prediction Table (LB-APT). In an embodiment, each slice has its own LB-APT. In an embodiment, if an allocating load hits the CAP, it writes the prediction into the local slice's LB-APT. When a producer load broadcasts a prediction, the consumer slice writes the prediction into its LB-APT and also attempts to bypass to loads currently in a receipt stage of the load pipeline. On a write bank conflict, received broadcasts and CAP hits are queued, or dropped if a queue is full. In turn, if a dispatching load finds a valid prediction in the APT, or can bypass a valid prediction from the broadcast bus, it arbitrates for the load pipeline early.

Referring to Tables 6 and 7 below, shown are exemplary details of an APT and an APT entry, respectively, in accordance with an embodiment.

TABLE 6
LB-APT Array Summary

| | |
|---|---|
| entries | 1680 |
| banks | 4 |
| read ports | 1 |
| write ports | 1 |

TABLE 7
LB-APT Entry

| Name | Width | Description |
|---|---|---|
| valid | 1 | Entry contains a prediction |
| vaddr | 48 | Predicted virtual address |

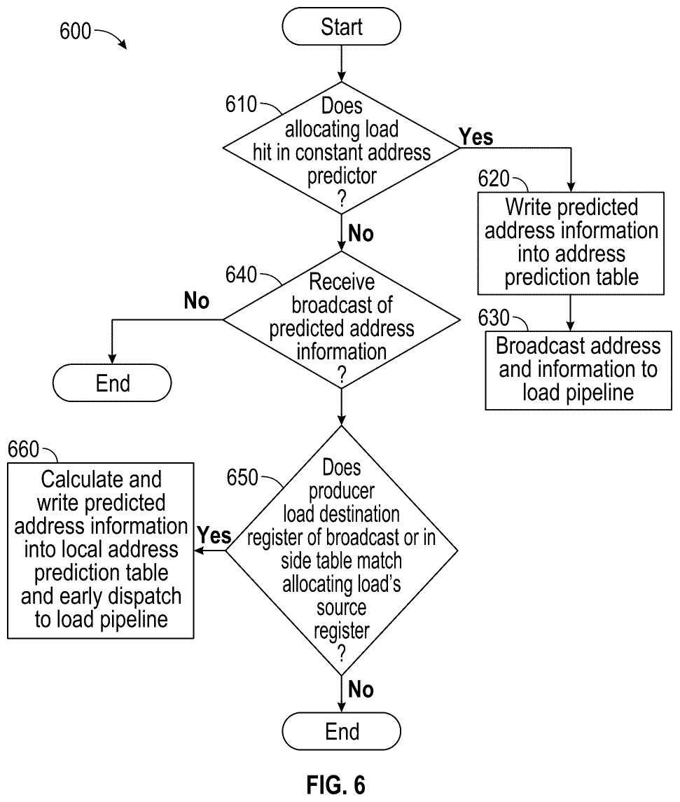

Referring now to FIG. 6, shown is a flow diagram of a method in accordance with yet another embodiment. More specifically, method 600 of FIG. 6 is a method for handling predictions using an address prediction table in accordance with an embodiment. As such, method 600 may be performed by hardware circuitry of a load pipeline and/or cache memory having such prediction circuitry.

As shown, method 600 begins by determining whether an allocating load hits in the constant address predictor (block 610). If so, control passes to block 620 where the predicted address information from the hit entry of the constant address predictor is written into an address prediction table of the slice. Then at block 630, the address and related information allocating load is broadcast to other slices.

Still referring to FIG. 6, additional address prediction table operations may occur, beginning at diamond 640, where it is determined if a broadcast (having predicted address information) is received from another slice of the cache memory. In this instance, control passes to diamond 650, where it is determined whether a producer destination register of this broadcast matches a consumer source register within a side table of the slice. If so, control passes to block 660, where an address calculation may be performed using this producer-consumer information. The calculated predicted address is written into the local address prediction table. In addition, this load may be bypassed to the load pipeline for early dispatch. If no match occurs as determined at diamond 650, no further operations occur with respect to the address prediction table. Although shown at this high level in the embodiment of FIG. 6, understand that many variations and alternatives are possible.

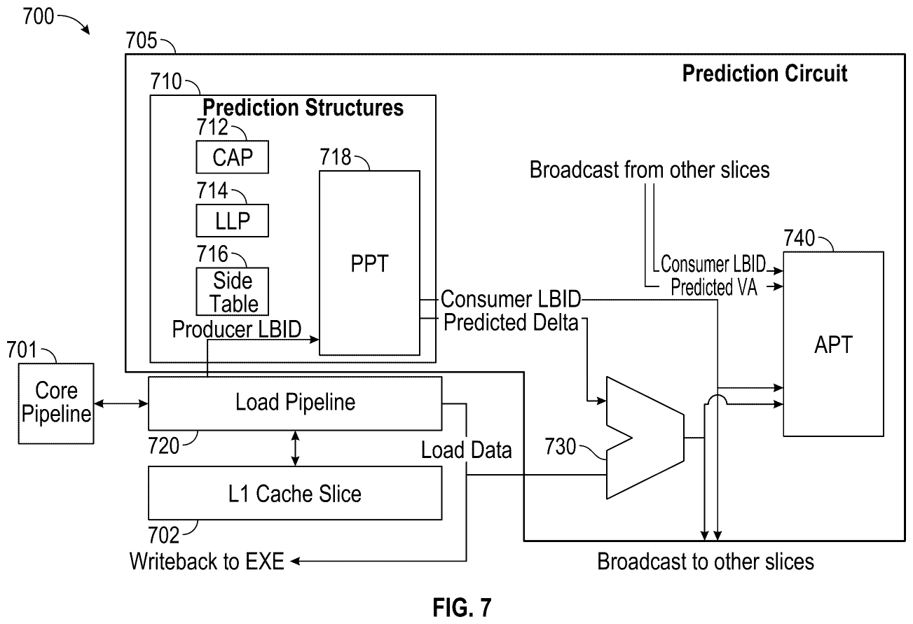

Referring now to FIG. 7, shown is a block diagram of a portion of a processor in accordance with an embodiment. As shown in FIG. 7, processor 700 is shown at a high level, including structures used for generating predicted addresses and calculating load addresses in part using these predicted addresses. Although while described herein as being implemented in association with an L1 cache memory, understand embodiments not limited in this regard. In other cases this prediction circuitry may be associated with or present in one or more other cache memories.

As illustrated, processor 700 includes a L1 cache memory 702 that is coupled, via a load pipeline 720, with a prediction circuit 705. As shown, prediction circuit 705 includes, inter alia, a set of prediction structures 710. In the high level shown in FIG. 7, these prediction structures include at least a CAP table 712, an LLP table 714, a side table 716, and a PPT 718. Understand that in addition to such tables, additional structures for generating and using predictions may be present. And in some embodiments, prediction circuit 705 (or at least portions thereof) may be included within cache memory 705. For example, in one or more embodiments prediction structures 710 may be implemented in one or more data arrays of cache memory 702.

Understand that load pipeline 720 is shown at a logical high level, and in practice may include structures present within core pipeline circuitry, cache memory 705 and memory hierarchy pipeline circuitry. In the high level shown, load pipeline 720 receives incoming load requests from a core pipeline 701 (e.g., allocate and/or dispatch, and AGU stages), and provides at an output load data (load writeback data received from a memory hierarchy) that is written back to execution circuitry of core pipeline 701. In general, load pipeline 720 accesses one or more prediction structures 710 before accessing L1 cache memory 702 to determine a predicted address to early dispatch the load and obtain requested data. Such table access would occur somewhere at the beginning of load pipeline 720.

As further shown, prediction information from PPT 718 (e.g., a predicted delta) and the load data is provided to an address generation unit 730. In one or more embodiments, address generation unit 730 may be a simple unit capable of basic calculations. Address generation unit 730 may generate prediction addresses from this information that it provides to an additional prediction structure, namely, address prediction table (APT) 740. Also shown, these predicted addresses and an associated consumer identifier, e.g., a load buffer identifier (LBID), are broadcast to other slices. Thus the writeback data obtained via load pipeline 720 may be used to generate a predicted virtual address that is broadcast along with a consumer LBID (as indicated on the bottom right portion of the diagram). APT 740 may store a given LBID and predicted VA in a given entry.

As further shown, additional entries may be populated with incoming broadcast information from other slices. Still further, dispatched loads may be provided to APT 740 to determine whether a given entry is associated with the load, such that a predicted address can be provided, e.g., to load pipeline 720. Note that in some cases, prediction circuit 705 and its associated structures may be controlled to be enabled or disabled based on a configuration setting, based at least in part on a configuration setting, e.g., of a configuration register of the processor. This configuration setting may be controlled to enable prediction circuit 705 based at least in part on types of workloads being executed (and/or to disable it for other workloads). Although shown at this high level in the embodiment of FIG. 7, many variations and alternatives are possible.

For example in an alternate embodiment, instead of having an APT, some number of the most recently received broadcasts may be searched using information of an incoming load. Also, dispatching loads can instead look up the CAP table and dispatch early if they hit.

Also in an alternate embodiment, if a load writing back might be a producer for a simple load, it broadcasts its writeback data along with its PDST. Simple loads match their PSRC against broadcast PDSTs. If a load hits, it calculates its predicted address using the broadcasted data and its immediate offset. If a load writing back hits the LLP, it calculates the predicted consumer address and broadcasts it with consumer IP.

As discussed above, address predictions allow loads that dispatch from OOO circuitry to arbitrate for the load pipeline before their AGU result is received from EXE circuitry. When the OOO circuitry sends a load dispatch packet, each slice looks for a prediction in its LB-APT and received broadcasts using the load's LBID. In an embodiment, only one load per load port is selected to look for predictions. If a load finds an in-slice prediction, the load arbitrates for early dispatch, which has a lower priority than regular dispatch timing, in an embodiment. Note that multiple slices could dispatch the same load at once if there are multiple conflicting predictions. Once the AGU result is received from EXE circuitry, a load that dispatched early verifies its virtual address. If it mismatches, the load re-cycles with the correct address.

In some embodiments, instead of waiting for OOO circuitry to dispatch a consumer load, the cache memory could dispatch the load into the load pipeline as soon as an address prediction is available. In this case, the cache memory can send a wakeup/writeback for the load before it schedules from OOO circuitry, and ensure that when OOO circuitry does eventually schedule it, no duplicate wakeups are sent. This arrangement would remove the most cycles possible from the load-to-load path, and allow constant address-predicted loads to schedule soon after allocation. Note that in these embodiments, the AGU result may arrive after the load has written back based on a predicted address, meaning the address verification may have to restart execution at the load.

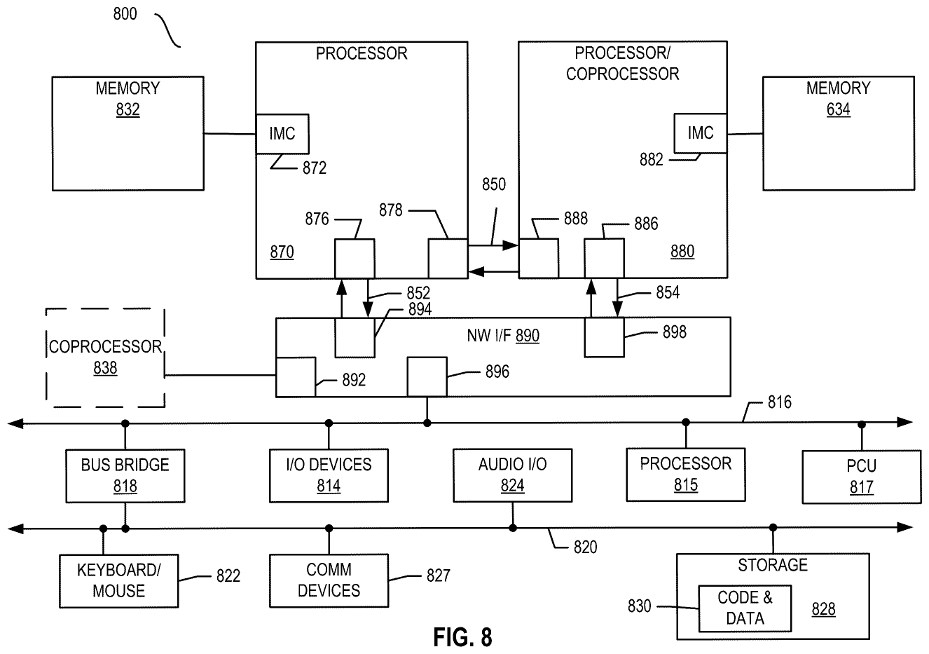

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a SoC.

Processors 870 and 880 are shown including integrated memory controller (IMC) circuitry 872 and 882, respectively. In one or more embodiments, processors 870 and 880 may include cache memory hierarchies including sliced caches having prediction circuitry as described herein. Processor 870 also includes interface circuits 876 and 878; similarly, second processor 880 includes interface circuits 886 and 888. Processors 870, 880 may exchange information via the interface 850 using interface circuits 878, 888, and may include cache memories that are configured to maintain information to indicate an amount of function-associated data stored locally, as described herein. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

Network interface 890 may be coupled to a first interface 816 via interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

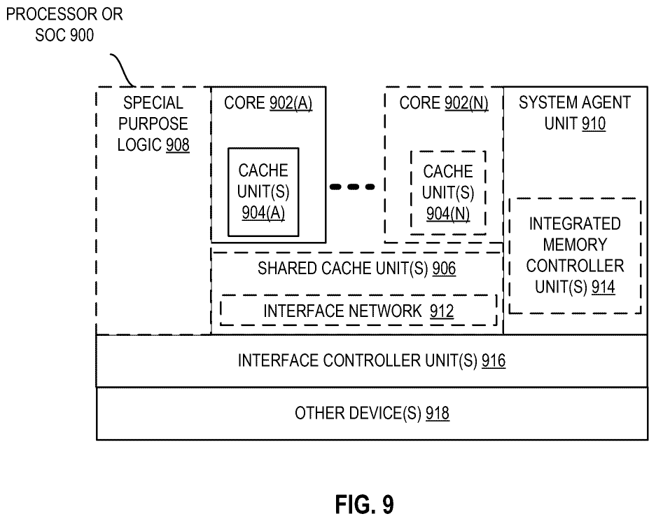

FIG. 9 illustrates a block diagram of an example processor and/or SoC 900 that may have one or more cores and an integrated memory controller. The solid lined boxes illustrate a processor 900 with a single core 902(A), system agent unit circuitry 910, and a set of one or more interface controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interface controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N) (e.g., including sliced caches having prediction circuitry as described herein), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller unit circuitry 916 couple the cores 902 to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

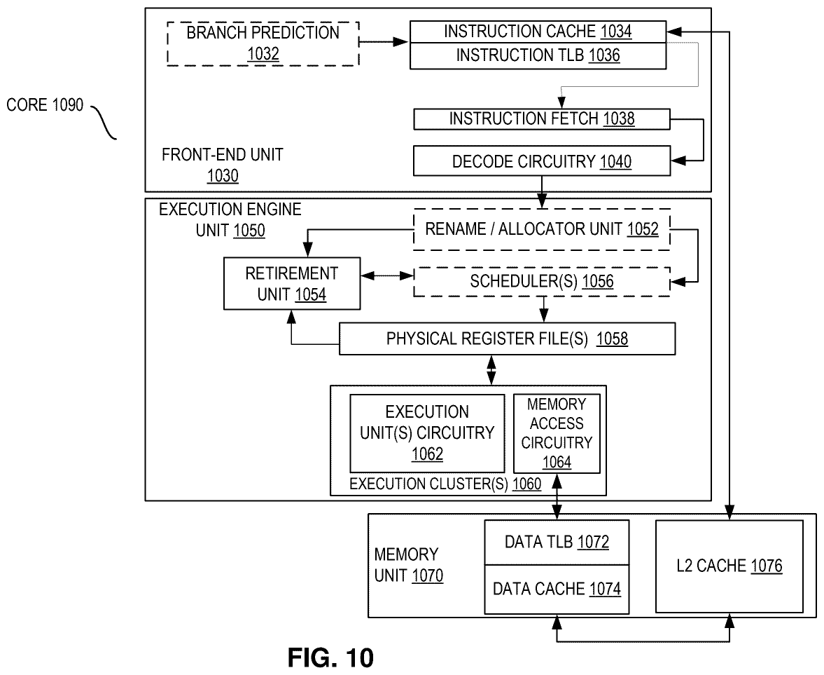

FIG. 10 shows a processor core 1090 including front-end unit circuitry 1030 coupled to execution engine unit circuitry 1050, and both are coupled to memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front-end unit circuitry 1030 may include branch prediction circuitry 1032 coupled to instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions including the cache filter configuration instruction described herein, and generate as an output one or more micro-operations, micro-code entry points, microinstructions, other instructions, or other control signals, which are decoded from, or which otherwise reflect, or are derived from, the original instructions. The decode circuitry 1040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front-end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, address generation unit (AGU) scheduler/scheduling circuitry, AGU queues, etc.

The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to data cache circuitry 1074 (e.g., including sliced caches having prediction circuitry as described herein), coupled to level 2 (L2) cache circuitry 1076. In one example, the memory access circuitry 1064 may include load unit circuitry, store address unit circuitry, and store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 870. In one example, the instruction cache 1034 and the data cache 1074 are combined into a single instruction and data cache (not shown) in L2 cache circuitry 1076, level 3 (L3) cache circuitry (not shown), and/or main memory. The L2 cache circuitry 1076 is coupled to one or more other levels of cache and eventually to a main memory.

The following examples pertain to further embodiments.

In one example, a method comprises: receiving, at a prediction circuit associated with a cache memory of a processor, a load operation to load information stored in a memory; and dispatching the load operation to a load pipeline of the processor using a predicted virtual address for the load operation, the predicted virtual load address for the load operation based on prediction information, associated with the load operation, from at least one prediction structure of the prediction circuit.

In an example, the method further comprises arbitrating between the load operation and at least one other load operation for dispatch to the load pipeline.

In an example, the method further comprises dispatching the at least one other load operation to the load pipeline before the load operation, wherein the at least one other load operation has a first priority and the load operation has a second priority, the first priority greater than the second priority.

In an example, the method further comprises: receiving, from an address generation circuit, a calculated virtual address of the load operation; and comparing the calculated virtual address of the load operation to the predicted virtual address for the load operation.

In an example, the method further comprises in response to the calculated virtual address of the load operation matching the predicted virtual address for the load operation, updating a confidence counter associated with the load operation in the at least one prediction structure to indicate a greater confidence for the predicted virtual address.

In an example, the method further comprises: in response to the calculated virtual address of the load operation not matching the predicted virtual address for the load operation, updating a confidence counter associated with the load operation in the at least one prediction structure to indicate a lesser confidence for the predicted virtual address; and recycling the load operation to the load pipeline with the virtual address of the load operation received from the address generation circuit.

In an example, the method further comprises: receiving, in a first portion of the cache memory, a broadcast message from a second portion of the cache memory, the broadcast message comprising an identifier of a producer load operation and a predicted virtual address for the producer load operation; and storing, in an entry of a second table of the at least one prediction structure, at least the predicted virtual address of the producer load operation.

In an example, the method further comprises storing an entry in a third table of the at least one prediction structure for a producer load operation, the entry including link information to identify a link between the producer load operation and a consumer load operation, the link information comprising a delta value based on a difference between a virtual address of the consumer load operation and writeback data of the producer load operation.

In another example, an apparatus comprises: at least one execution circuit to execute instructions; a load pipeline coupled to the at least one execution circuit to process load operations to obtain data from a memory; a cache memory coupled to the load pipeline, the cache memory comprising at least one storage array to store at least a portion of the data, at least one prediction structure to store a plurality of entries, each of the plurality of entries comprising prediction information associated with a load operation; and prediction circuitry coupled to the at least one prediction structure, wherein the prediction circuitry is to dispatch a first load operation to the load pipeline using first prediction information obtained from a first entry of the at least one prediction structure.

In an example, the cache memory comprises a plurality of slices, each of the plurality of slices to store information of a different range of addresses from the memory.

In an example, each of the plurality of slices is associated with a corresponding instance of the at least one prediction structure and the prediction circuitry.

In an example, a first slice of the plurality of slices is to send prediction information to at least a second slice of the plurality of slices, the second slice to store the prediction information in the corresponding instance of the at least one prediction structure.

In an example, the at least one storage array further comprises the at least one prediction structure.

In an example, based at least in part on a configuration setting, the apparatus is to enable the prediction circuitry to access the at least one prediction structure.

In an example, the apparatus further comprises an address generation circuit, and the prediction circuitry is to dispatch the first load operation to the load pipeline before the address generation circuit has calculated a virtual address for the first load operation.

In an example, the prediction circuitry further comprises a second address generation circuit, the second address generation circuit to calculate a predicted virtual address for a consumer load operation based on consumer prediction information of the consumer load operation and writeback data of a producer load operation.

In another example, a method comprises: receiving, at prediction circuitry associated with a cache memory of a processor, a load operation to load information stored in a memory; and dispatching the load operation to a load pipeline of the processor using a predicted virtual address for the load operation, the predicted virtual load address for the load operation based on prediction information, associated with the load operation, from at least one prediction structure of the prediction circuit.

In an example, the method further comprises indexing into a first table of the at least one prediction structure using at least a portion of an instruction pointer of the load operation to obtain the prediction information from an entry of the first table.

In an example, the method further comprises dispatching the load operation to the load pipeline of the processor using the predicted virtual address when a value of a confidence field of the entry of the first table exceeds a first threshold.

In an example, the method further comprises dispatching the load operation to the load pipeline of the processor using a calculated virtual address when the value of the confidence field of the entry of the first table does not exceed the first threshold, the calculated virtual address received in the load pipeline a plurality of cycles after the load operation.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving, at a prediction circuit associated with a cache memory of a processor, a load operation to load information stored in a memory; and
dispatching the load operation to a load pipeline of the processor using a predicted virtual address for the load operation, the predicted virtual load address for the load operation based on prediction information, associated with the load operation, from at least one prediction structure of the prediction circuit.

2. The method of claim 1, further comprising arbitrating between the load operation and at least one other load operation for dispatch to the load pipeline.

3. The method of claim 2, further comprising dispatching the at least one other load operation to the load pipeline before the load operation, wherein the at least one other load operation has a first priority and the load operation has a second priority, the first priority greater than the second priority.

4. The method of claim 1, further comprising:
receiving, from an address generation circuit, a calculated virtual address of the load operation; and
comparing the calculated virtual address of the load operation to the predicted virtual address for the load operation.

5. The method of claim 4, further comprising in response to the calculated virtual address of the load operation matching the predicted virtual address for the load operation, updating a confidence counter associated with the load operation in the at least one prediction structure to indicate a greater confidence for the predicted virtual address.

6. The method of claim 4, further comprising:
in response to the calculated virtual address of the load operation not matching the predicted virtual address for the load operation, updating a confidence counter associated with the load operation in the at least one prediction structure to indicate a lesser confidence for the predicted virtual address; and
recycling the load operation to the load pipeline with the virtual address of the load operation received from the address generation circuit.

7. The method of claim 1, further comprising:
receiving, in a first portion of the cache memory, a broadcast message from a second portion of the cache memory, the broadcast message comprising an identifier of a producer load operation and a predicted virtual address for the producer load operation; and
storing, in an entry of a second table of the at least one prediction structure, at least the predicted virtual address of the producer load operation.

8. The method of claim 1, further comprising storing an entry in a third table of the at least one prediction structure for a producer load operation, the entry including link information to identify a link between the producer load operation and a consumer load operation, the link information comprising a delta value based on a difference between a virtual address of the consumer load operation and writeback data of the producer load operation.

9. An apparatus comprising:
at least one execution circuit to execute instructions;
a load pipeline coupled to the at least one execution circuit to process load operations to obtain data from a memory;
a cache memory coupled to the load pipeline, the cache memory comprising at least one storage array to store at least a portion of the data;
at least one prediction structure to store a plurality of entries, each of the plurality of entries comprising prediction information associated with a load operation; and
prediction circuitry coupled to the at least one prediction structure, wherein the prediction circuitry is to dispatch a first load operation to the load pipeline using first prediction information obtained from a first entry of the at least one prediction structure.

10. The apparatus of claim 9, wherein the cache memory comprises a plurality of slices, each of the plurality of slices to store information of a different range of addresses from the memory.

11. The apparatus of claim 10, wherein each of the plurality of slices is associated with a corresponding instance of the at least one prediction structure and the prediction circuitry.

12. The apparatus of claim 11, wherein a first slice of the plurality of slices is to send prediction information to at least a second slice of the plurality of slices, the second slice to store the prediction information in the corresponding instance of the at least one prediction structure.

13. The apparatus of claim 9, wherein the at least one storage array further comprises the at least one prediction structure.

14. The apparatus of claim 9, wherein based at least in part on a configuration setting, the apparatus is to enable the prediction circuitry to access the at least one prediction structure.

15. The apparatus of claim 9, wherein the apparatus further comprises an address generation circuit, and the prediction circuitry is to dispatch the first load operation to the load pipeline before the address generation circuit has calculated a virtual address for the first load operation.

16. The apparatus of claim 15, wherein the prediction circuitry further comprises a second address generation circuit, the second address generation circuit to calculate a predicted virtual address for a consumer load operation based on consumer prediction information of the consumer load operation and writeback data of a producer load operation.

17. At least one computer readable medium comprising instructions, which when executed by a processor, cause the processor to execute a method comprising:
receiving, at prediction circuitry associated with a cache memory of a processor, a load operation to load information stored in a memory; and
dispatching the load operation to a load pipeline of the processor using a predicted virtual address for the load operation, the predicted virtual load address for the load operation based on prediction information, associated with the load operation, from at least one prediction structure of the prediction circuit.

18. The at least one computer readable medium of claim 17, wherein the method further comprises indexing into a first table of the at least one prediction structure using at least a portion of an instruction pointer of the load operation to obtain the prediction information from an entry of the first table.

19. The at least one computer readable medium of claim 18, wherein the method further comprises dispatching the load operation to the load pipeline of the processor using the predicted virtual address when a value of a confidence field of the entry of the first table exceeds a first threshold.

20. The at least one computer readable medium of claim 19, wherein the method further comprises dispatching the load operation to the load pipeline of the processor using a calculated virtual address when the value of the confidence field of the entry of the first table does not exceed the first threshold, the calculated virtual address received in the load pipeline a plurality of cycles after the load operation.
